(19) United States
(12) Patent Application Publication
(10) Pub. No.: US 2025/0132142 A1
(43) Pub. Date: Apr. 24, 2025

(54) Ion Analyzer and Ion Analyzing Method

(71) Applicant: SHIMADZU CORPORATION, Kyoto-shi (JP)

(72) Inventors: Yuta MIYAZAKI, Kyoto-shi (JP); Hidenori TAKAHASHI, Kyoto-shi (JP)

(21) Appl. No.: 18/919,191

(22) Filed: Oct. 17, 2024

(30) Foreign Application Priority Data
Oct. 19, 2023 (JP) 2023-180561

(51) Int. Cl. H01J 49/16; H01J 49/24; H01J 49/42

(52) U.S. Cl. CPC H01J 49/165; H01J 49/24; H01J 49/4215

(57) ABSTRACT

In an ion analyzer which dissociates an ion using a radical generated from a source gas, a gas supplier (26) supplies the source gas by selecting a gas from multiple kinds of gases and/or mixing two or more of those gases. The source gas is introduced into a generation chamber (210). A power supplier (25) supplies electric power for generating electric discharge within the generation chamber. A controller (3) controls those two suppliers as follows: When the radical is to be generated from a first gas through which electric discharge is relatively difficult to occur, the electric discharge is initiated by supplying electric power into the generation chamber while a second gas through which electric discharge occurs more easily is selected or mixed with the first gas and supplied to the generation chamber. After the electric discharge is initiated, the first gas is selectively supplied to the generation chamber.

### TECHNICAL FIELD

The present invention relates to an ion analyzer and an ion analyzing method for analyzing an ion originating from a target component contained in a sample.

### BACKGROUND ART

In order to identify a sample component (e.g., a high-molecular compound) contained in a sample and analyze its structure, the technique of mass spectrometry has been widely used in which an ion having a specific mass-to-charge ratio (m/z) is selected from ions originating from the sample component, and various product ions generated by dissociating that ion are detected after being separated from each other according to their mass-to-charge ratios. Various methods have been known as techniques for dissociating ions. One of those known techniques is a radical-induced dissociation method in which various kinds of radicals are made to attach to or react with an ion to dissociate this ion (although this technique may also be called the “radical attachment dissociation method”, the term “radical-induced dissociation method” is used in the present description).

For example, Patent Literature 1 discloses a method in which radical-induced dissociation of an ion is caused by irradiating the ion with hydroxyl (OH) radical, oxygen radical, nitrogen radical or other kinds of radicals generated by radio-frequency electric discharge, and the thereby generated product ions are subjected to mass spectrometry. Patent Literature 2 discloses that the location of a double bond which determines the bioactivity of a lipid can be analyzed by an MS/MS analysis employing a radical-induced dissociation method which uses hydroxyl and oxygen radicals.

Patent Literature 3 discloses one example of a radical generation device for generating radicals to be used in the previously described radical-induced dissociation method. This radical generation device has a helical antenna including a quartz tube with a strip of conductor wound around its outer circumferential surface. Source gas, such as steam, is introduced into the quartz tube, and radiofrequency (microwave) power is supplied to the helical antenna to generate a cloud of plasma within the quartz tube and create radicals within this plasma. A magnet generating a strong magnetic field is placed on the outside of the quartz tube. This magnetic field induces electron cyclotron resonance, which increases the density of the plasma within the quartz tube as well as stabilizes the generation of that plasma. Due to the use of the locally induced electric discharge and the electron cyclotron resonance for the generation and maintenance of the plasma, this radical generation device may also be called an ECR-LICP (Electron Cyclotron Resonance-Localized Inductively Coupled Plasma) type.

### CITATION LIST

### Patent Literature

Patent Literature 1: WO 2018/186286 A

Patent Literature 2: WO 2019/155725 A

Patent Literature 3: WO 2022/059247 A

Patent Literature 4: WO 2021/053865 A

### SUMMARY OF INVENTION

### Technical Problem

As noted earlier, various kinds of radicals can be used in radical-induced dissociation methods. It is preferable to selectively use radical species according to the purpose of the analysis, kind of compound and other factors. One possible method for selectively using various radical species in a single mass spectrometer is to change the kind of source gas supplied to the previously described type of radical generation device. For example, in the configuration adopted in a mass spectrometer disclosed in Patent Literature 4, either the hydroxyl and oxygen radicals or the hydrogen radical can be selectively introduced into the collision cell by switching the source gas between steam and hydrogen gas. Hydrogen radical can be used for dissociating an ion. Additionally, due to its reducing effect, hydrogen radical also acts as a remover of an oxide film formed on the surface of an electrode within a collision cell by hydroxyl radical or the like.

However, since the ionization energy and other related factors vary with the kind of gas, it depends on the kind of gas how easily an electric discharge occurs when radiofrequency power is supplied. This poses the problem that, when an attempt is made to ignite plasma after the kind of source gas supplied to the radical generation device has been switched in order to change the radical species to be supplied to the collision cell, the electric discharge cannot occur in a stable form, or in some cases, no electric discharge occurs and no radicals can be generated.

The present invention has been developed to solve those problems. Its primary objective is to provide an ion analyzer and an ion analyzing method capable of generating an electric discharge in a stable form in a radical generation device and satisfactorily supplying the radicals, regardless of the kind of source gas from which radicals are to be generated.

### Solution to Problem

One mode of the ion analyzer according to the present invention is an ion analyzer configured to dissociate an ion originating from a sample by bringing the ion into contact with a radical generated from a source gas, the ion analyzer including:
a gas supplier configured to prepare a gas by selecting one from a plurality of kinds of gases and/or by mixing two or more of the plurality of kinds of gases, and to supply the gas as the source gas;
a generation chamber into which the source gas supplied from the gas supplier is to be introduced;
a power supplier configured to supply electric power for generating an electric discharge within the generation chamber; and
a controller configured to control the gas supplier and the power supplier so that, when a radical originating from a first gas through which an electric discharge is relatively difficult to occur among the plurality of kinds of gases is to be generated, the electric discharge is initiated by supplying electric power into the generation chamber while a second gas through which an electric discharge occurs more easily than through the first gas is selected or mixed with the first gas in the gas supplier and supplied to the generation chamber, and after the electric discharge is initiated, the first gas is selected and supplied to the generation chamber.

One mode of the ion analyzing method according to the present invention is an ion analyzing method which includes a step of dissociating an ion originating from a sample by bringing the ion into contact with a radical generated from a source gas within a generation chamber in an ion analyzer which includes: a gas supplier configured to prepare a gas by selecting one from a plurality of kinds of gases and/or by mixing two or more of the plurality of kinds of gases, and to supply the gas as the source gas; the generation chamber into which the source gas supplied from the gas supplier is to be introduced; and a power supplier configured to supply electric power for generating an electric discharge within the generation chamber, the ion analyzing method further including, when a radical originating from a first gas through which an electric discharge is relatively difficult to occur among the plurality of kinds of gases is to be generated:
a first step in which the electric discharge is initiated by supplying electric power into the generation chamber while a second gas through which an electric discharge occurs more easily than through the first gas is selected or mixed with the first gas in the gas supplier and supplied to the generation chamber; and
a second step in which, after the first step is performed, the first gas is selected and supplied to the generation chamber.

### Advantageous Effects of Invention

In the previously described modes of the present invention, an electric discharge can be generated in a stable form to ignite plasma and generate a radical even when the source gas from which the radical is to be generated is a gas species through which an electric discharge is difficult to occur. Therefore, by the previously described modes of the present invention, an ion can be dissociated in a stable form as well as in an efficient manner by the effect of the radical, and an analysis of the ions produced by the dissociation can be satisfactorily performed.

### BRIEF DESCRIPTION OF DRAWINGS

FIG. 1 is a schematic configuration diagram of a mass spectrometer as one embodiment of the present invention.

FIG. 2 is a configuration diagram of the main components of a radical generator in the mass spectrometer according to the present embodiment.

FIG. 3 is a control flowchart for initiating an analysis in the mass spectrometer according to the present embodiment.

FIG. 4 is a graph showing an example of how to regulate the flow rate of each kind of gas depending on the kind of source gas in the mass spectrometer according to the present embodiment.

### DESCRIPTION OF EMBODIMENTS

One embodiment of the ion analyzer and the ion analyzing method according to the present invention is hereinafter described with reference to the attached drawings. Although the following descriptions address a mass spectrometer as an embodiment of the ion analyzer, it is evident from the following descriptions that the present invention is not limited to this type of device but may also be applied in an ion mobility spectrometer or ion mobility-mass spectrometer.

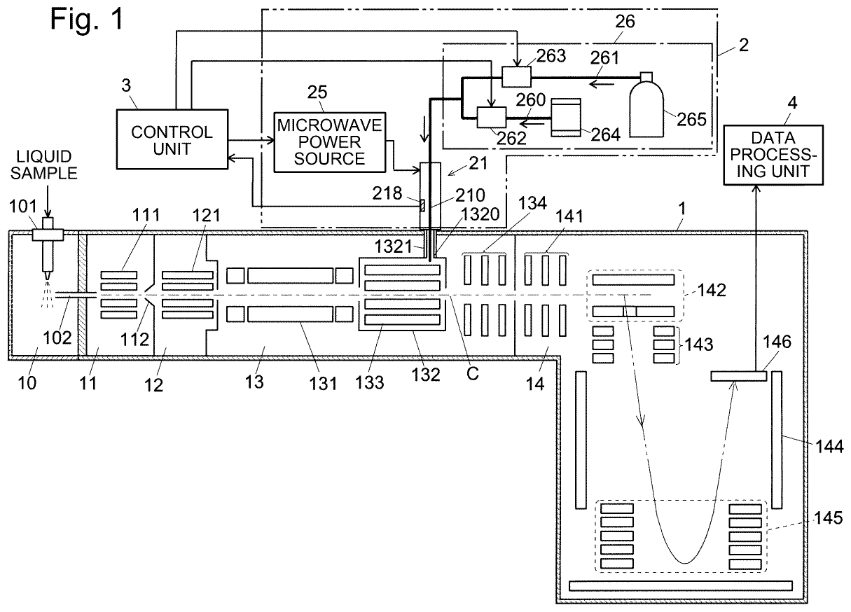

FIG. 1 is a schematic configuration diagram of the mass spectrometer according to the present embodiment. This mass spectrometer is a quadrupole time-of-flight (Q-TOF) mass spectrometer including an atmospheric pressure ion source.

As shown in FIG. 1, this mass spectrometer includes an ionization chamber 10 and a vacuum chamber 1. The inside of the ionization chamber 10 is at substantially atmospheric pressure. The inner space of the vacuum chamber 1 is divided into a plurality of sections (in the present embodiment, four chambers), which are a first intermediate vacuum chamber 11, second intermediate vacuum chamber 12, first analysis chamber 13 and second analysis chamber 14 sequentially arranged from the ionization chamber 10. Each of these chambers is evacuated by a vacuum pump (a rotary pump and/or a turbomolecular pump, not shown), forming the configuration of a multi-stage differential pumping system in which the degree of vacuum sequentially increases in the direction from the ionization chamber 10 toward the second analysis chamber 14.

The ionization chamber 10 is provided with an electrospray ionization (ESI) probe 101 configured to spray a liquid sample while imparting electric charges to the same sample. The ionization chamber 10 communicates with the first intermediate vacuum chamber 11 through a thin desolvation tube 102. The first intermediate vacuum chamber 11 is separated from the second intermediate vacuum chamber 12 by a skimmer 112 having a small hole at its apex. Ion guides 111 and 121 are located within the first and second intermediate vacuum chambers 11 and 12, respectively. Within the first analysis chamber 13, a quadrupole mass filter 131 configured to separate ions according to their m/z, a collision cell 132 having a multipole ion guide 133 inside, and an ion transport electrode 134 for transporting ions, are arranged along an ion beam axis C. The quadrupole mass filter 131 and the multipole ion guide 133 are each formed by a plurality of rod electrodes, while the ion transport electrode 134 is formed by a plurality of ring electrodes.

The collision cell 132 has an opening 1320 formed in its wall, with a cylindrical tube connection member 1321 provided so that one of its ends surrounds the opening 1320. A quartz tube 210 extending from a radical generation unit 2 is inserted into the tube connection member 1321. The end of the quartz tube 210 protrudes through the opening 1320 into the collision cell 132. Within the collision cell 132, an ion is dissociated by radical species supplied from the radical generation unit 2, as will be described later. Though not shown, the collision cell 132 may be configured to receive a supply of gas for causing collision-induced dissociation (CID) within the collision cell 132 (typically, argon gas), other than the radicals supplied from the radical generation unit 2.

Within the second analysis chamber 14, the following components are provided: an ion transport electrode 141 for transporting ions coming from the first analysis chamber 13; an orthogonal accelerator 142 including a pair of electrodes facing each other across the beam axis C of ions; an acceleration electrode 143; a flight tube 144 internally forming a flight space; a reflectron electrode 145 configured to form a return path for ions within the flight space; and an ion detector 146 configured to detect ions. For example, the ion detector 146 may be a multichannel plate detector. The detection signals produced by the ion detector 146 are sent to a data processing unit 4. A control unit 3 is configured to control the radical generation unit 2 and the data processing unit 4 as well as other components, including power sources for applying voltages to the related elements, although the signal lines required for the control are partially omitted in the drawing.

A typical analysis operation performed under the control of the control unit 3 in the mass spectrometer configured in the previously described manner is as follows:

The ESI probe 101 receives a liquid sample supplied, for example, from the exit end of a column in a liquid chromatograph and sprays the liquid sample into the ionization chamber 10 while imparting electric charges to the same liquid sample, whereby a compound in the liquid sample is ionized. The generated ions are sent into the first intermediate vacuum chamber 11 through the desolvation tube 102. The ions which have entered the first intermediate vacuum chamber 11 are transferred through the ion guide 11, small hole of the skimmer 112 and ion guide 121 into the first analysis chamber 13, within which the ions are introduced into the quadrupole mass filter 131.

Among the various kinds of introduced ions, an ion having a specific m/z value is selectively allowed to pass through the quadrupole mass filter 131 and be introduced into the collision cell 132. Meanwhile, radical species are introduced from the radical generation unit 2 into the collision cell 132 through the quartz tube 210. The aforementioned ion introduced into the collision cell 132 is dissociated by reacting with the radical species. The various product ions resulting from the dissociation are extracted from the collision cell 132 and introduced into the orthogonal accelerator 142 through the ion transport electrodes 134 and 141.

The ions introduced into the orthogonal accelerator 142 along the ion beam axis Care ejected in a direction substantially orthogonal to the ion beam axis C at an appropriate timing. The ejected ions are accelerated by the acceleration electrode 143 and introduced into the flight space within the flight tube 144. The flying ions are repelled by the electric field created by the reflectron electrode 145 and ultimately reach the ion detector 146. The ion detector 146 produces a detection signal corresponding to the amount of incident ions. This signal is sent to the data processing unit 4. The period of time from the departure time of an ion from the orthogonal accelerator 142 to the arrival time of the ion at the ion detector 146, i.e., the time of flight of an ion, depends on the m/z value of that ion. Accordingly, based on the detection signals, the data processing unit 4 creates a time-of-flight spectrum showing the relationship between time of flight and ion intensity, and further creates a mass spectrum by converting the time of flight into the m/z value.

The detailed configuration of the radical generation unit 2 and its operation are hereinafter described.

As shown in FIG. 1, the radical generation unit 2 includes a plasma generator 21. The plasma generator 21 generates a cloud of plasma from a source gas, such as steam, supplied from a source-gas supply source 26. The radicals generated in this plasma are supplied to the collision cell 132. A microwave power source 25 supplies the plasma generator 21 with microwave power for generating plasma.

The source-gas supply source 26 incudes a steam supply tube 260 provided with a first mass flow controller 262, a hydrogen supply tube 261 provided with a second mass flow controller 263, a water storage unit 264 connected to the inlet end of the steam supply tube 260, and a hydrogen cylinder 265 connected to the inlet end of the hydrogen supply tube 261. The steam and hydrogen supply tubes 260 and 261 have their remaining ends connected to the quartz tube 210. The water storage unit 264, which is equipped with a heater (not shown), can generate steam by heating the stored water and supply that steam through the steam supply tube 260.

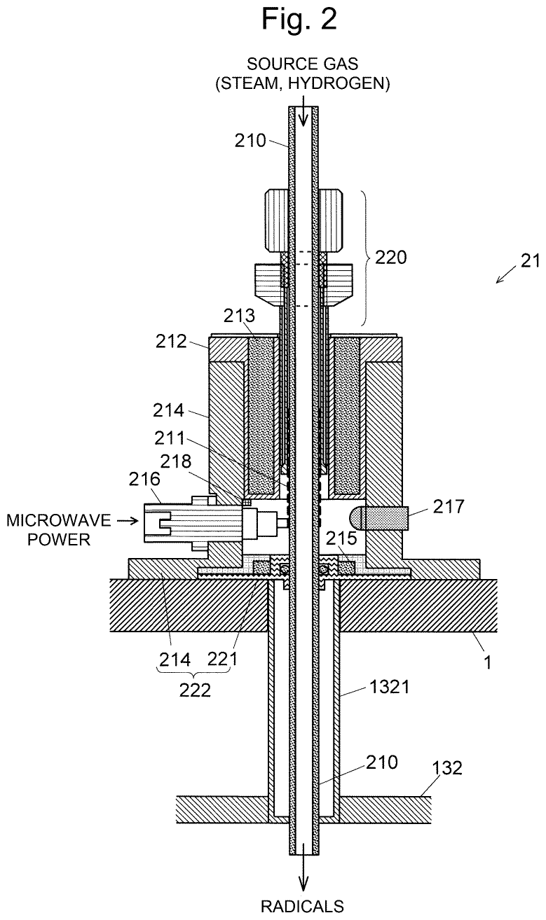

FIG. 2 is a vertical sectional view of the main components including the plasma generator 21.

The plasma generator 21 has the following components: a long quartz tube 210; a helical antenna 211 consisting of a strip of conductor helically wound around the outer circumferential surface of a portion of the quartz tube 210; an outer conductive part 212 consisting of a conductor having a cylindrical cavity which is coaxial with the quartz tube 210 and has an inner diameter slightly larger than the outer diameter of the quartz tube 210; a permanent magnet 213 buried in the outer conductive part 212; a casing 214 holding the outer conductive part 212; and a permanent magnet 215 located at the bottom of the casing 214. The casing 214 is provided with a microwave supply connector 216, ultraviolet light source 217 and photodetector 218. When deep ultraviolet light is cast from the ultraviolet light source 217 onto the quartz tube 210, electrons are released from the wall surface of the quartz tube 210. Those electrons spark (ignite) the plasma.

The quartz tube 210 is a source-gas introduction tube for introducing a source gas from the source-gas supply source 26. Additionally, the inner space of this tube partially acts as a generation chamber, and partially as a radical passage. The microwave supply connector 216 is a coaxial connector to be connected to the microwave power source 25 via a coaxial cable. The conductor wire of the microwave supply connector 216 is connected to one end (in FIG. 2, the lower end) of the helical antenna 211. Though not shown, the outer conductive part 212 is grounded. A portion of the helical antenna 211 is electrically connected to the outer conducive part 212 via a resonator-tuning mechanism 220, and the helical antenna 211 is grounded at the point of that connection. The helical antenna 211, outer conductive part 212, resonator-tuning mechanism 220 and other related elements constitute a resonator for electron cyclotron resonance. The resonator-tuning mechanism 220, an example of which is disclosed in Patent Literature 3, is used for tuning the resonator.

This plasma generator 21 has a configuration called the “ECR-LICP” type which employs localized inductively coupled discharge and electron cyclotron resonance for the generation and maintenance of plasma.

On the bottom side of the casing 214, a substantially disk-shaped magnet holder 221 is attached. The casing 214 and the magnet holder 221 function as a holding member 222 for holding the quartz tube 210. The magnet holder 221 has an opening located in its central area through which the quartz tube 210 is to be inserted. As shown in FIG. 2, the plasma generator 21 is attached to the outer surface of the vacuum chamber 1, and the quartz tube 210 held by the holding member 222 is inserted into the tube connection member 1321 connecting the collision cell 132 and the vacuum chamber 1, reaching the inside of the collision cell 132. Since the inner space of the quartz tube 210 communicates with that of the collision cell 132, the inside of the quartz tube 210 will be in a vacuum state when no source gas is supplied to the quartz tube 210.

Next, a control operation for performing an analysis by supplying a radical into the collision cell 132 by operating the radical generation unit 2 in the mass spectrometer according to the present embodiment is described.

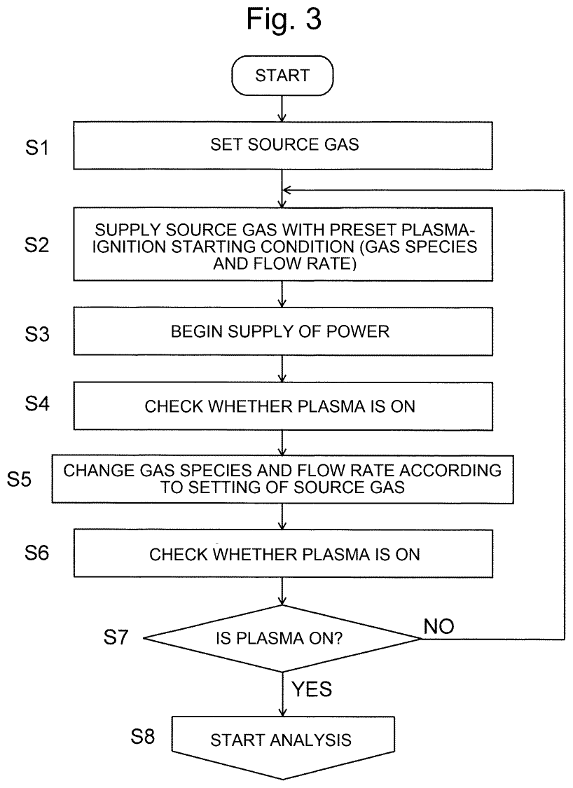

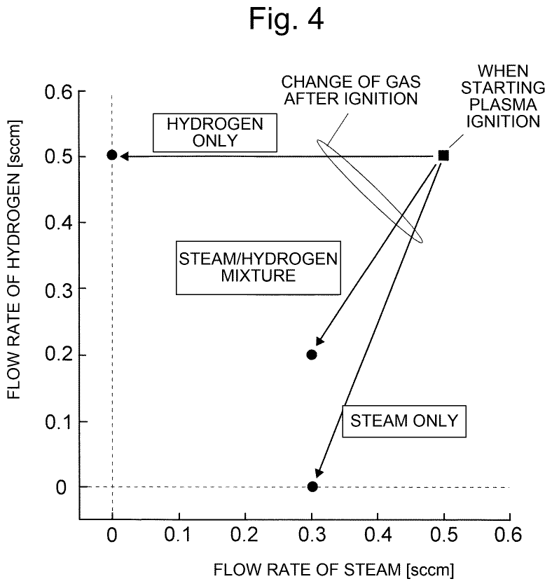

FIG. 3 is a control flowchart of this operation. FIG. 4 is a graph showing an example of how to regulate the flow rate of each kind of gas depending on the kind of source gas.

The mass spectrometer according to the present embodiment is configured to allow users to appropriately select one of the three options as the source gas from which radicals are to be generated in the radical generation unit 2: a mixture of steam and hydrogen; steam only, and hydrogen only. Accordingly, in advance of the analysis, the user performs an operation on an input unit (not shown) for selecting the source gas from those three options. Upon receiving this operation, the control unit 3 sets the source gas to be used (Step S1). This setting of the source gas does not always need to be made in response to the selection of the gas species in the previously described manner; for example, it may also be made in response to the designation of the kind of sample (compound) by the user. The device may also be configured to automatically determine the kind of source gas without requiring the selection or designation by the user. In any case, what is required in this step is to determine the source gas to be used for generating a radical.

When a command to initiate an analysis has been issued, the control unit 3 initially regulates the flow rates of the first and second mass flow controllers 262 and 263 so that the source gas is supplied to the quartz tube 210 under preset plasma-ignition starting conditions which include the gas species and flow rates (Step S2). Specifically, in the present case, as shown in FIG. 4, the flow rates of the mass flow controllers 262 and 263 are set so that a gas mixture of steam (0.5 sccm) and hydrogen (0.5 sccm) is supplied as the source gas. The gas species and gas flow rates in this step are independent of the source gas set in Step S1. That is to say, even when “hydrogen only” or “steam only” is selected as the source gas, the source gas used in the plasma ignition phase is the gas mixture of steam and hydrogen. Due to their difference in ionization energy and other factors, steam is easier to induce radiofrequency electric discharge than hydrogen. In other words, the electric discharge is difficult to occur when hydrogen is solely used, but when steam is mixed with the hydrogen, the electric discharge can occur more easily than when hydrogen is solely used.

Next, the control unit 3 energizes the microwave power source 25 in order to ignite the plasma which is in the OFF state. The energized microwave power source 25 begins to supply a specified amount of microwave power to the plasma generator 21 (Step S3). The microwave has, for example, a frequency of 2.5 GHz. The control unit 3 also energizes the ultraviolet light source 217 to initiate emission of deep ultraviolet light for helping the sparking of the plasma. It should be noted that the use of the ultraviolet light source 217 for helping the plasma ignition is not essential for the present invention.

Due to the microwave power supplied into the quartz tube 210, the source gas is ionized, and the plasma ignites. The degree of the ease of the plasma ignition in this stage is always the same since the gas conditions in the plasma ignition phase are identical regardless of the kind of source gas set in Sep S1.

The photodetector 218 detects light of a wavelength band including the wavelength of the light emitted from the plasma. In order to avoid detecting the light emitted from the ultraviolet light source 217, the photodetector 218 should preferably have no sensibility to the wavelength of this light. To this end, a photodiode having sensibility to the visible region (and no or low sensibility to the ultraviolet region) is used as the photodetector 218. This allows the plasma emission to be satisfactorily detected without being affected by the light emitted from the ultraviolet light source 217.

The control unit 3 monitors the output signal from the photodetector 218 at the point in time where a predetermined period of time (e.g., 1 to 10 seconds) has passed since the beginning of the plasma ignition phase, and determines, based on the signal value, whether or not the plasma is in the ON state (Step S4). The control unit 3 waits until the determination result in Step S4 indicates that the plasma is in the ON state. When the ON state has been confirmed, the operation proceeds to Step S5. If a predetermined time limit (e.g., an appropriate period of time not shorter than 10 seconds) has passed without the plasma being confirmed to be in the ON state, it is most likely that some problem has occurred, such as a problem with the supply path of the microwave power or an inappropriate supply of the source gas. In such a case, an appropriate measure can be taken, such as informing the user of an abnormality.

After proceeding to Step S5, the control unit 3 regulates the flow rates of the first and second mass flow controllers 262 and 263 so that the source gas specified in Step S1 is supplied to the quartz tube 210 under preset conditions according to the kind of specified source gas.

In general, igniting plasma from the state in which the plasma is completely in the OFF state requires ensuring a sufficiently high level of gas flow rate. Once the plasma has been ignited, the plasma can be easily maintained in the ON state even when the gas species is changed or even when the gas flow rate is lowered to a certain extent. Accordingly, in the present embodiment, the setting of the flow rates of the first and second mass flow controllers 262 and 263 is changed as shown in FIG. 4 so that hydrogen is solely supplied at 0.5 sccm when “hydrogen only” is set as the source gas, or steam is solely supplied at 0.3 sccm when “steam only” is set as the source gas, or a source gas prepared by mixing steam (0.3 sccm) and hydrogen (0.2 sccm) is supplied when “mixture of steam and hydrogen” is set as the source gas. As noted earlier, once the plasma has been ignited, the ON state of the plasma can be easily maintained even when the gas species is changed or even when the flow rate of the gas is lowered since there are a large number of electrons flying around within the quartz tube 210 (generation chamber). Therefore, for example, even when hydrogen is solely supplied as the source gas after the supply of the steam which helps the electric discharge to occur has been discontinued, the electric discharge can be easily maintained with hydrogen only.

Needless to say, it is not absolutely impossible that the plasma goes out when the gas species is changed or the flow rate of the gas is lowered. Accordingly, after the kind of gas and/or its flow rate has been changed to a condition according to the setting, the control unit 3 monitors the output signal from the photodetector 218 to determine, based on the signal value, whether or not the plasma is in the ON state (Step S6). When it has been concluded that the plasma is in the ON state, the operation proceeds from Step S7 to Step S8 to initiate an MS/MS analysis employing the radical-induced dissociation method. When it is possible to conclude that the plasma is in the OFF state in Step S7, the operation returns to Step S2, and the control unit 3 once more attempts the previously described control for plasma ignition.

While an analysis is performed in Step S8, the total flow rate of the source gas is lower than in the plasma ignition phase, regardless of the kind of source gas. Therefore, the amount of gas flowing into the collision cell 132, and further into the vacuum chamber 1, is decreased, which helps avoiding unwanted phenomena (e.g., a decrease in ion transmission efficiency) that result from a decrease in the degree of vacuum.

Thus, the mass spectrometer according to the present embodiment can satisfactorily generate an electric discharge to ignite plasma and generate radicals in that plasma, regardless of the kind of source gas from which radicals are to be generated, i.e., even when a kind of gas through which an electric discharge is difficult to occur is used as the source gas.

In the case of generating plasma by radiofrequency electric discharge, commonly used methods for generating a stable electric discharge using a gas species through which an electric discharge is difficult to occur are to increase the energy of the supplied power or to increase the gas flow rate. However, adopting the former method in a mass spectrometer causes problems, such as an increase in weight as well as in cost due to the increased size of the components related to the power unit, or an increase in failure rate due to an extreme heating of the device. Adopting the latter method in a mass spectrometer also causes problems, such as a deterioration in the degree of vacuum within the vacuum chamber, which easily causes failure due to the occurrence of unwanted vacuum discharge within that chamber, as well as an increase in cost due to the necessity of the use of a high-performance vacuum pump.

By comparison, in the mass spectrometer according to the present embodiment, the ease of plasma ignition can be improved by simply changing the control of the mass flow controllers provided for changing the gas species or regulating the flow rates. Therefore, there is no substantial increase in cost, and an increase in the size and weight of the microwave power source 25 can also be avoided. The flow rate of the gas introduced into the vacuum chamber 1 can also be reduced, so that an occurrence of unwanted vacuum discharge can also be avoided.

In the previous description, the gas species and flow rates were quickly changed in Step S5. It is also possible to gradually increase or decrease the gas flow rates so that the gas species and flow rates will transition to a modified state over a certain period of time. For example, when the source gas should ultimately be hydrogen only, the amount of steam can be gradually decreased after the confirmation of the plasma ignition so that only hydrogen will ultimately be supplied as the source gas. Needless to say, possible conditions of the gas flow rates are not limited to those shown in FIG. 4, which are mere examples.

In the previously described mass spectrometer, only steam and hydrogen are used as the source gas from which radicals are to be generated. It is easy to conceive the idea that the present invention is also applicable in the case of using other gas species, such as nitrogen, as the source gas.

The previously described embodiment is an example in which the ion analyzer according to the present invention is applied in a Q-TOF mass spectrometer. It is evident that the present invention is not limited to the Q-TOF type. Specifically, the present invention is also applicable in other types of mass spectrometers in which an ion is dissociated for mass spectrometry, such as a triple quadrupole mass spectrometer, ion trap mass spectrometer or ion trap time-of-flight mass spectrometer.

The present invention is generally applicable in devices configured to dissociate an ion by using a radical generated in plasma and analyze product ions generated by the dissociation. Specifically, for example, the present invention is applicable in an ion mobility spectrometer configured to detect ions after separating them according to their ion mobility, as well as in an ion mobility-mass spectrometer configured to separate ions by using both ion mobility and m/z.

The configuration of the previously described mass spectrometer, and particularly that of the radical generation unit 2 for generating radicals, is a mere example and can naturally be appropriately changed or modified to any configuration that can generate radicals by using plasma. The radicals in the present context include hydroxyl radical, hydrogen radical, oxygen radical, nitrogen radical and other kinds of radicals commonly used for radical-induced dissociation methods, as well as various kinds of molecules and atoms which are in an excited state due to externally imparted energy or in a metastable state.

The previously described embodiment and various modifications are mere examples of the present invention. It is evident that any change, modification, addition or the like appropriately made within the spirit of the present invention will also fall within the scope of claims of the present application.

### Various Modes

A person skilled in the art can understand that the previously described illustrative embodiment is a specific example of the following modes of the present invention.

(Clause 1) One mode of the ion analyzer according to the present invention is an ion analyzer configured to dissociate an ion originating from a sample by bringing the ion into contact with a radical generated from a source gas, the ion analyzer including:
a gas supplier configured to prepare a gas by selecting one from a plurality of kinds of gases and/or by mixing two or more of the plurality of kinds of gases, and to supply the gas as the source gas;
a generation chamber into which the source gas supplied from the gas supplier is to be introduced;
a power supplier configured to supply electric power for generating an electric discharge within the generation chamber; and
a controller configured to control the gas supplier and the power supplier so that, when a radical originating from a first gas through which an electric discharge is relatively difficult to occur among the plurality of kinds of gases is to be generated, the electric discharge is initiated by supplying electric power into the generation chamber while a second gas through which an electric discharge occurs more easily than through the first gas is selected or mixed with the first gas in the gas supplier and supplied to the generation chamber, and after the electric discharge is initiated, the first gas is selected and supplied to the generation chamber.

(Clause 5) One mode of the ion analyzing method according to the present invention is an ion analyzing method which includes a step of dissociating an ion originating from a sample by bringing the ion into contact with a radical generated from a source gas within a generation chamber in an ion analyzer which includes: a gas supplier configured to prepare a gas by selecting one from a plurality of kinds of gases and/or by mixing two or more of the plurality of kinds of gases, and to supply the gas as the source gas; the generation chamber into which the source gas supplied from the gas supplier is to be introduced; and a power supplier configured to supply electric power for generating an electric discharge within the generation chamber, the ion analyzing method further including, when a radical originating from a first gas through which an electric discharge is relatively difficult to occur among the plurality of kinds of gases is to be generated:
a first step in which the electric discharge is initiated by supplying electric power into the generation chamber while a second gas through which an electric discharge occurs more easily than through the first gas is selected or mixed with the first gas in the gas supplier and supplied to the generation chamber; and
a second step in which, after the first step is performed, the first gas is selected and supplied to the generation chamber.

By the ion analyzer according to Clause 1 and the ion analyzing method according to Clause 5, an electric discharge can be generated in a stable form to ignite plasma and generate a radical even when the source gas from which the radical is to be generated is a gas species through which an electric discharge is difficult to occur. Therefore, by the ion analyzer according to Clause 1 and the ion analyzing method according to Clause 5, an ion can be dissociated in a stable form as well as in an efficient manner by the effect of the radical, and an analysis of the ions produced by the dissociation can be satisfactorily performed.

(Clause 2) In the ion analyzer according to Clause 1, the gas supplier may be configured to be capable of supplying, as the source gas, one gas selected from the group consisting of the first gas, the second gas as well as a gas mixture of the first gas and the second gas, and the controller may be configured to control the gas supplier so as to use a same gas mixture for initiating an electric discharge, regardless of which gas among the aforementioned group is used as the source gas.

(Clause 6) In the ion analyzing method according to Clause 5, the gas supplier may be configured to be capable of supplying, as the source gas, one gas selected from the group consisting of the first gas, the second gas as well as a gas mixture of the first gas and the second gas, and the first step may include initiating the electric discharge using a same gas mixture, regardless of which gas among the aforementioned group is used as the source gas.

In the ion analyzer according to Clause 2 and the ion analyzing method according to Clause 6, the same gas condition for initiating an electric discharge is applied regardless of the kind of source gas from which radicals are to be generated. This eliminates the influence of the kind of source gas on the conditions of the plasma ignition phase, such as the period of time required for the plasma ignition, so that the plasma ignition can always be achieved in a stable form. It also facilitates the task of clearing up the cause of failure when the plasma ignition was unsuccessful.

(Clause 3) In the ion analyzer according to Clause 1 or 2, the first gas may be hydrogen gas, and the second gas may be steam.

(Clause 7) In the ion analyzing according to Clause 5 or 6, the first gas may be hydrogen gas, and the second gas may be steam.

In the ion analyzer according to Clause 3 and the ion analyzing method according to Clause 7, for example, when hydroxyl radical and oxygen radical need to be supplied into a reaction chamber, steam can be used as the source gas. When hydrogen radical needs to be supplied into the reaction chamber, hydrogen gas can be used as the source gas. When the hydroxyl and oxygen radicals as well as the hydrogen radical need to be simultaneously supplied into the reaction chamber, a gas mixture of steam and hydrogen can be used as the source gas. Although hydrogen is a kind of gas through which an electric discharge is less likely to occur than through steam, the ion analyzer according to Clause 3 and the ion analyzing method according to Clause 7 can satisfactorily initiate an electric discharge and supply hydrogen radical into the reaction chamber in a stable manner even when hydrogen is used as the source gas.

(Clause 4) In the ion analyzer according to one of Clauses 1-3, the controller may be configured to control the gas supplier so as to initially select the second gas in the gas supplier to continuously supply the second gas to the generation chamber and initiate an electric discharge by supplying electric power into the generation chamber, and to subsequently switch the gas supplied to the generation chamber from the second gas to the first gas by gradually decreasing the flow rate of the second gas while gradually increasing the flow rate of the first gas.

(Clause 8) In the ion analyzing method according to one of Clauses 5-7, the first step may include initiating the electric discharge by supplying electric power into the generation chamber while supplying the second gas into the generation chamber, and the second step may include switching the gas supplied to the generation chamber from the second gas to the first gas by gradually decreasing the flow rate of the second gas while gradually increasing the flow rate of the first gas.

The ion analyzer according to Clause 4 and the ion analyzing method according to Clause 8 lower the risk that the electric discharge ceases and the plasma goes out in the process of switching from a gas species through which an electric discharge more easily occurs to a gas species through which an electric discharge is relatively difficult to occur.

### Reference Signs List

1 . . . Vacuum Chamber

10 . . . Ionization Chamber

101 . . . ESI Probe

102 . . . Desolvation Tube

11 . . . First Intermediate Vacuum Chamber

111, 121 . . . Ion Guide

112 . . . Skimmer

12 . . . Second Intermediate Vacuum Chamber

13 . . . First Analysis Chamber

131 . . . Quadrupole Mass Filter

132 . . . Collision Cell

1320 . . . Opening

1321 . . . Tube Connection Member 133 . . . Multipole Ion Guide

134, 141 . . . Ion Transport Electrode

14 . . . Second Analysis Chamber

142 . . . Orthogonal Accelerator

143 . . . Acceleration Electrode

144 . . . Flight Tube

145 . . . Reflectron Electrode

146 . . . Ion Detector

2 . . . Radical Generation Unit

21 . . . Plasma Generator

210 . . . Quartz Tube

211 . . . Helical Antenna

212 . . . Outer Conductive Part

213, 215 . . . Permanent Magnet

214 . . . Casing

216 . . . Microwave Supply Connector

217 . . . Ultraviolet Light Source

218 . . . Photodetector

220 . . . Resonator-Tuning Mechanism

221 . . . Magnet Holder

222 . . . Holding Member

25 . . . Microwave Power Source

26 . . . Source-Gas Supply Source

260 . . . Steam Supply Tube

261 . . . Hydrogen Supply Tube

262, 263 . . . Mass Flow Controller

264 . . . Water Storage Unit

265 . . . Hydrogen Cylinder

3 . . . Control Unit

4 . . . Data Processing Unit

C . . . Ion Beam Axis

1. An ion analyzer configured to dissociate an ion originating from a sample by bringing the ion into contact with a radical generated from a source gas, the ion analyzer comprising:
a gas supplier configured to prepare a gas by selecting one from a plurality of kinds of gases and/or by mixing two or more of the plurality of kinds of gases, and to supply the gas as the source gas;
a generation chamber into which the source gas supplied from the gas supplier is to be introduced;
a power supplier configured to supply electric power for generating an electric discharge within the generation chamber; and
a controller configured to control the gas supplier and the power supplier so that, when a radical originating from a first gas through which an electric discharge is relatively difficult to occur among the plurality of kinds of gases is to be generated, the electric discharge is initiated by supplying electric power into the generation chamber while a second gas through which an electric discharge occurs more easily than through the first gas is selected or mixed with the first gas in the gas supplier and supplied to the generation chamber, and after the electric discharge is initiated, the first gas is selected and supplied to the generation chamber.

2. The ion analyzer according to claim 1, wherein the gas supplier is configured to be capable of supplying, as the source gas, one gas selected from a group consisting of the first gas, the second gas as well as a gas mixture of the first gas and the second gas, and the controller is configured to control the gas supplier so as to use a same gas mixture for initiating an electric discharge, regardless of which gas among the aforementioned group is used as the source gas.

3. The ion analyzer according to claim 1, wherein the first gas is hydrogen gas, and the second gas is steam.

4. The ion analyzer according to claim 1, wherein the controller is configured to control the gas supplier so as to initially select the second gas in the gas supplier to continuously supply the second gas to the generation chamber and initiate an electric discharge by supplying electric power into the generation chamber, and to subsequently switch the gas supplied to the generation chamber from the second gas to the first gas by gradually decreasing a flow rate of the second gas while gradually increasing a flow rate of the first gas.

5. An ion analyzing method which includes a step of dissociating an ion originating from a sample by bringing the ion into contact with a radical generated from a source gas within a generation chamber in an ion analyzer which includes: a gas supplier configured to prepare a gas by selecting one from a plurality of kinds of gases and/or by mixing two or more of the plurality of kinds of gases, and to supply the gas as the source gas; the generation chamber into which the source gas supplied from the gas supplier is to be introduced; and a power supplier configured to supply electric power for generating an electric discharge within the generation chamber, the ion analyzing method further comprising, when a radical originating from a first gas through which an electric discharge is relatively difficult to occur among the plurality of kinds of gases is to be generated:
a first step in which the electric discharge is initiated by supplying electric power into the generation chamber while a second gas through which an electric discharge occurs more easily than through the first gas is selected or mixed with the first gas in the gas supplier and supplied to the generation chamber; and
a second step in which, after the first step is performed, the first gas is selected and supplied to the generation chamber.

6. The ion analyzing method according to claim 5, wherein the gas supplier is configured to be capable of supplying, as the source gas, one gas selected from the group consisting of the first gas, the second gas as well as a gas mixture of the first gas and the second gas, and the first step includes using a same gas mixture for initiating the electric discharge, regardless of which gas among the aforementioned group is used as the source gas.

7. The ion analyzing method according to claim 5, wherein the first gas is hydrogen gas, and the second gas is steam.

8. The ion analyzing method according to claim 5, wherein:
the first step includes initiating the electric discharge by supplying electric power into the generation chamber while supplying the second gas into the generation chamber; and
the second step includes switching the gas supplied to the generation chamber from the second gas to the first gas by gradually decreasing a flow rate of the second gas while gradually increasing a flow rate of the first gas.

9. The ion analyzer according to claim 2, wherein the first gas is hydrogen gas, and the second gas is steam.

10. The ion analyzing method according to claim 6, wherein the first gas is hydrogen gas, and the second gas is steam.
